(19) United States
(12) Patent Application Publication
(10) Pub. No.: US 2018/0063480 A1
(43) Pub. Date: Mar. 1, 2018

(54) GALLERY VIEW IN ONLINE MEETING SYSTEMS

(71) Applicant: MICROSOFT TECHNOLOGY LICENSING, LLC, Redmond, WA (US)

(72) Inventors: Ilgin Luks, Redmond, WA (US); Devi Brunsch, Redmond, WA (US); Somasundaram K. Beerana, Redmond, WA (US)

(73) Assignee: MICROSOFT TECHNOLOGY LICENSING, LLC, Redmond, WA (US)

(21) Appl. No.: 15/338,602

(22) Filed: Oct. 31, 2016

Related U.S. Application Data
(60) Provisional application No. 62/380,971, filed on Aug. 29, 2016.

(51) Int. Cl. H04N 7/15; G10L 17/00; G06F 3/0484

(52) U.S. Cl. CPC H04N 7/15; G06F 3/0484; G10L 17/005

(57) ABSTRACT

Gallery views in online meeting user interfaces are described. Participants may be represented on a gallery that includes a subset of participants in an online meeting. Each item in the gallery may include a video feed from a participant or a representation of a participant (a picture, an icon, etc.). A dominant speaker may be identified based on a number of factors and a history of participants' activities. Based on participation history and other factors, people may be removed or added from/to the gallery. Timestamps may be used to keep track of which participant speaks when and for how long. If no one is currently speaking, gallery spots may be filled with active participants, participants with video feeds, or at random. Participants may be enabled to select between the representation gallery, content gallery, or content views (e.g., shared data, applications, etc.).

### CROSS-REFERENCE TO RELATED APPLICATION

This application claims benefit under 35 U.S.C. §119(e) of U.S. Provisional Application No. 62/380,971 filed on Aug. 29, 2016. The U.S. Provisional Application is herein incorporated by reference in its entirety.

### BACKGROUND

Online conferencing systems allow people at any location to communicate with each other not only through audio and video modes, but also share data, collaborate, exchange messages, and take advantage of other communication techniques. While functionality and capabilities of online conferencing systems vary, the way information is presented to the participants may degrade or enhance user experience. Thus, for an efficient online conferencing system, selection and layout of functionality aspects may be a substantive operational parameter.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to gallery views in online meeting user interfaces. In some examples, a subset of participants to be represented in a gallery view may be determined based on one or more of a speaking status, a speaking history, a video feed status, and a random selection. A dominant speaker may be determined next based on one or more of who is speaking, who is an important attendee, who is presenting, and similar factors. The dominant speaker may be included in the gallery view by removing one of the subset of participants based on one or more of the speaking status, the speaking history, the video feed status of the subset of participants. The gallery view may then be provided to a client application to be displayed.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes an example network environment where a system to provide gallery views in online meeting user interfaces may be implemented;

FIG. 2 illustrates conceptually example components in providing gallery views in online meeting user interfaces;

FIGS. 3A and 3B illustrate example distribution of people and content in gallery views in online meeting user interfaces;

FIGS. 4A and 4B illustrate example distribution of people in gallery views in online meeting user interfaces;

FIGS. 5A and 5B illustrate example user interfaces with different people display configurations;

FIG. 6 is a networked environment, where a system according to embodiments may be implemented;

FIG. 7 is a block diagram of an example general purpose computing device, which may be used to provide gallery views in online meeting user interfaces; and

FIG. 8 illustrates a logic flow diagram of a method to provide gallery views in online meeting user interfaces.

### DETAILED DESCRIPTION

As briefly described above, embodiments are directed to gallery views in online meeting user interfaces. In some examples, participants are represented on a gallery that includes a subset of all participants in a video conference. Each item in the gallery may include a video feed from a participant or a representation of a participant (a picture, an icon, etc.). A video conference module may identify a new dominant speaker and consult a history of participants' activities. From the history, the module may determine which participant spoke longest ago on the gallery and remove that participant from the gallery to bring in the new dominant speaker. Timestamps may be used to keep track of which participant speaks when and for how long. If no one is currently speaking, gallery spots may be filled with active participants, participants with video feeds, or at random. Participants may be enabled to select between the representation gallery, content gallery, or content views (e.g., shared data, applications, etc.). A small preview of panoramic view may also be provided in the gallery. A local panoramic view and a remote panoramic view may be presented in the gallery with different sizes and locations to indicate their nature. Panoramic view, if available, may be prioritized to be displayed in the gallery.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing gallery views in online meeting user interfaces. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

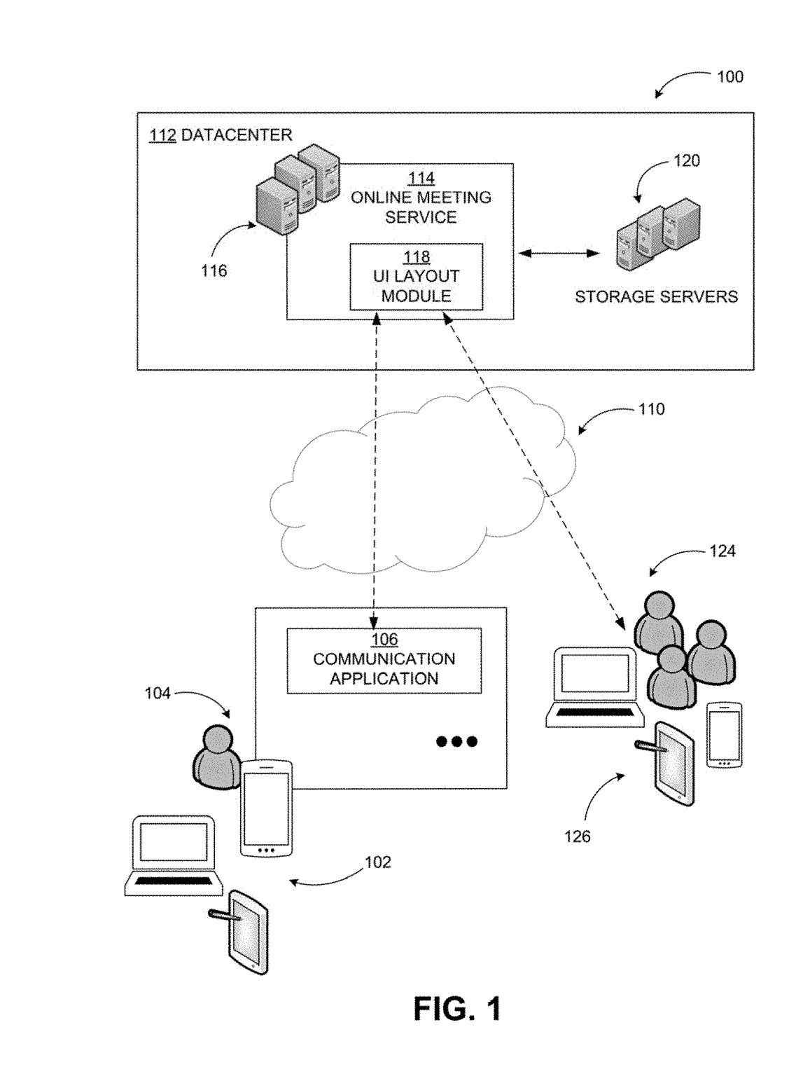

FIG. 1 includes an example network environment where a system to provide gallery views in online meeting user interfaces may be implemented.

As illustrated in diagram 100, an example system may include a datacenter 112 hosting a cloud-based online meeting service 114 configured to provide meeting scheduling services that may be accessed across multiple devices and users. The datacenter 112 may include one or more processing servers 116 configured to execute the online meeting service 114, among other components. In some embodiments, at least one of the processing servers 116 may be operable to manage the online meeting service 114, where data from devices (such as devices 102 and 126) may be stored at storage servers 120 (or associated data stores). As described herein, the online meeting service 114 may be implemented as software, hardware, or combinations thereof.

In some embodiments, the online meeting service 114 may be configured to intemperate with various applications to provide meeting management, calendar maintenance, and similar tasks. For example, as illustrated in the diagram 100, a user 104 may execute a thin (e.g., a web browser) or a thick (e.g., a locally installed client application) version of a communication application 106 through the device 102 with which the online meeting service 114 may be configured to integrate and intemperate with over one or more networks, such as network 110. The communication application 106 may be an application hosted by the online meeting service, such as meeting client, for example. The device 102 may include a desktop computer, a laptop computer, a tablet computer, a vehicle mount computer, a smart phone, or a wearable computing device, among other similar devices. A communication interface may facilitate communication between the online meeting service 114 and the communication application 106 over the network 110.

In an example embodiment, the online meeting service 114 may be configured to determine attributes of various meeting attendants and display video feeds from the attendants or representative icons (e.g., pictures) according to predefined, customizable, or dynamic configurations. For example, dominant speakers may be defined based on who is speaking, who is an important attendee, who is presenting, and similar factors. Furthermore, whether or not panoramic views are available may determine a layout of an online meeting user interface. Moreover, content such as presented information, chat sessions, and comparable items may be laid out in conjunction with the people being displayed on the user interface. In some embodiments, the people may be displayed in a gallery view configured according to the above discussed factors.

A system according to embodiments allows gallery views in online conference user interfaces. By determining an optimized presentation of attendees and other information in an online meeting user interface, increased efficiency, reduced local and cloud computing resource usage, reduced bandwidth usage, and increased security and collaboration may be achieved through avoidance of usage of multiple user interfaces, applications, and network channels. Furthermore, improved user interaction may be achieved by allowing users to see automatically most relevant views in an online conference instead of manual selection or not being able to see at all.

Embodiments, as described herein, address a need that arises from very large scale of operations created by software-based services that cannot be managed by humans. The actions/operations described herein are not a mere use of a computer, but address results of a system that is a direct consequence of software used as a service offered in conjunction with large numbers of devices and users facilitating online meetings.

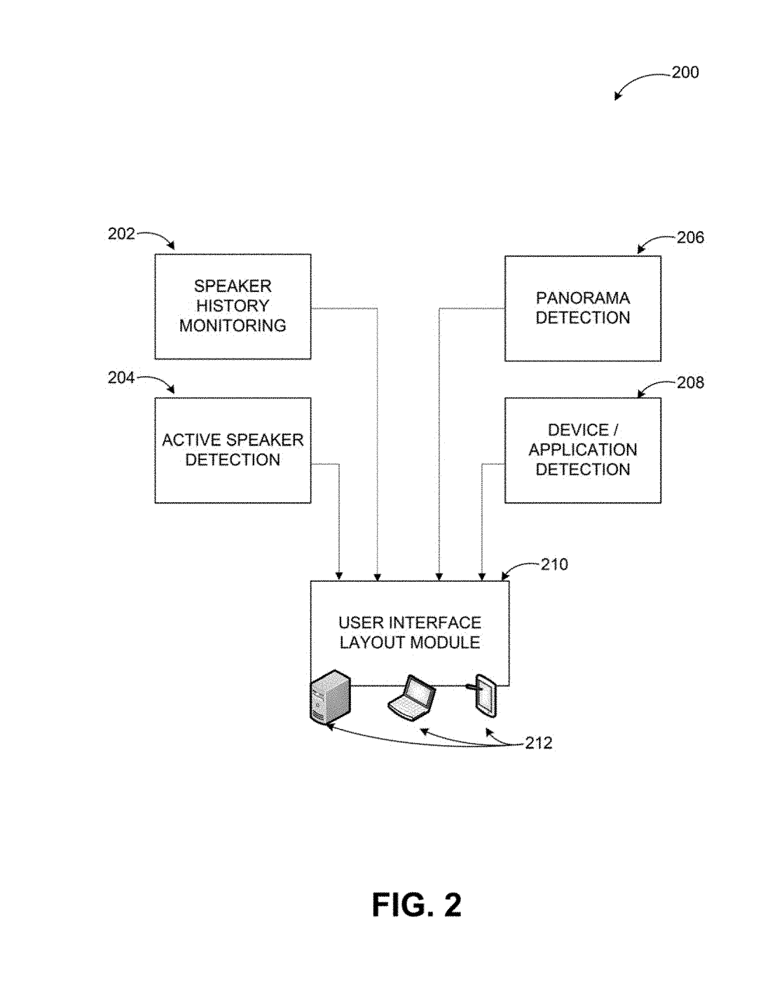

FIG. 2 illustrates conceptually example components in providing gallery views in online meeting user interfaces.

Diagram 200 shows various example inputs a user interface layout module 210 (e.g., UI layout module 722) may receive to automatically determine a layout and content of a gallery view for an online meeting and to dynamically adjust the layout and content based on changes such as who is speaking, which video feeds are available, and so on. A speaker history monitoring process 202 may provide information such as which participant spoke (or presented) when and for how long. That information may be detected and maintained using timestamps.

The speaker history monitoring process 202 may allow determination of which attendants are to be represented in the gallery view based a speaking history of each attendant. The speaking history may include, as discussed above, which attendant spoke, presented, or otherwise participated actively in the meeting when and for how long. In some scenarios, a current speaking status determined by an active speaker detection process 204 may not be sufficient to select which attendants are to be included in the gallery view. For example, too few or too many attendants may speak (or otherwise participate) compared to the number of available spots in the gallery view. In such scenarios, the speaking history may be used to determine the attendants to be included in the gallery view. For example, most recent speakers or attendants who spoke the longest may be selected for the gallery view.

An active speaker detection process 204 may be performed by a communication module or another component of the online meeting service and provide input to the user interface layout module 210 to help determine the speaking status and/or a dominant speaker. The speaking status may include which attendant is speaking, presenting, or otherwise participating actively in the online meeting at a current time. In some examples, the speaking status may also include whether or not an attendant has muted their connection to the online meeting. If there are fewer spots on the gallery view than total attendees, attendees who mute themselves may be removed from the gallery view to be replaced with other attendants who may or may not be speaking, but have an un-muted connection.

The active speaker detection process 204 may also determine the dominant speaker, which as used herein, refers to a meeting attendant who is to be presented in a dominant fashion. A dominant speaker may be one that is currently speaking. However, a dominant speaker may also be determined based on other factors such as if and how long a particular attendant spoke in the past, whether an attendant is an organizer of the meeting, whether an attendant is a presenter in the meeting, an organizational status of an attendant (e.g., a manager or supervisor), whether an attendant is an invited guest from outside an organization, and similar ones. An active speaker as used herein may refer to an attendant that is currently speaking, presenting, or participating actively in other ways.

The active speaker detection process 204 may further determine a video feed status of the attendants. In an example scenario, the online meeting may include video modality, but not all attendants may have a video feed (presenting themselves via video). Thus, it may be desirable to include those attendants with an active video feed in the gallery view to take full advantage of the online meeting's modalities.

A panorama detection process 206 may be performed by dedicated panorama view logic in some examples and allow the user interface layout module 210 to determine whether local or remote panoramic views are available and how to include them in the gallery.

A device and/or application detection process 208 may inform the user interface layout module 210 about a device and/or application used by each participant. Thus, the user interface layout module 210 may determine how to configure the gallery view based on a capacity or capability of the used device and/or application (e.g., available display area).

An online meeting service as discussed herein may be a standalone service or part of another cloud-based service such as a communication service, a collaboration service, a productivity service, or other comparable services.

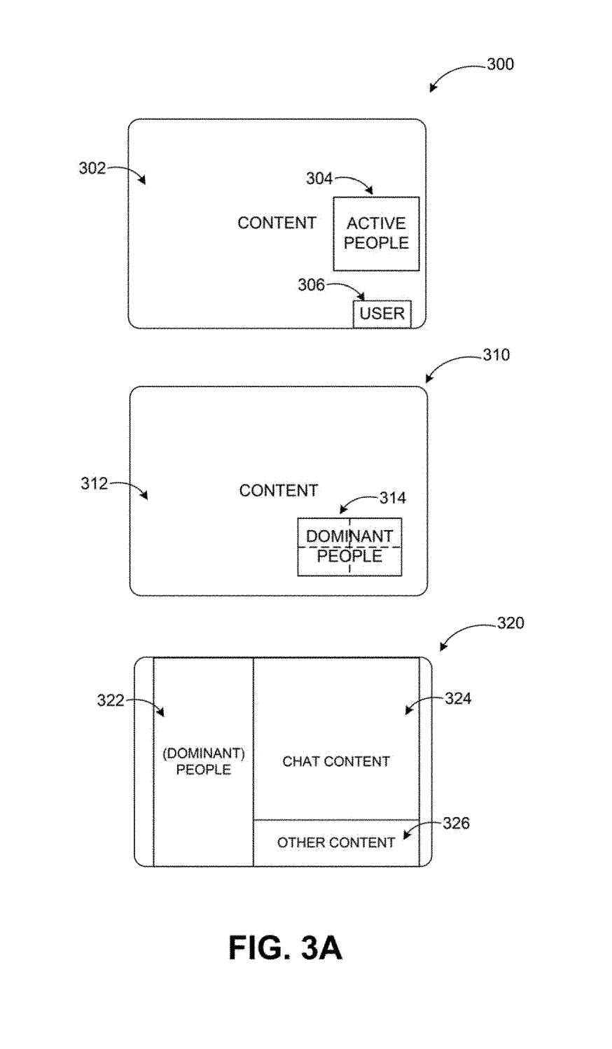

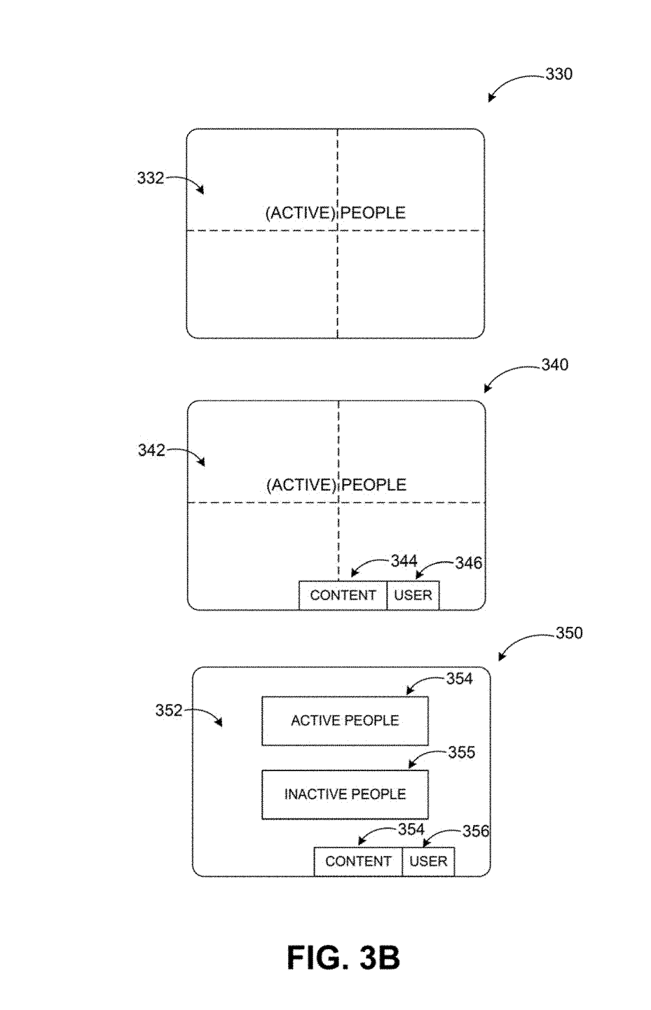

FIGS. 3A and 3B illustrate example distribution of people and content in gallery views in online meeting user interfaces.

Example user interface 300 of FIG. 3A shows an online meeting configuration where attendants are shown along with presented content. According to some embodiments, presented content may be selected to prevail. Thus, content 302 may be displayed to cover a majority of the display space of the online meeting user interface. To conserve display space and avoid crowding the displayed content, some attendants may be displayed along an edge (e.g., bottom or side) of the user interface. Because display space may be limited for people, a group of active people 304 (e.g., attendants who have spoken or presented during the meeting) may be displayed along one side of the user interface and the user 306 (the attendant using the particular online meeting user interface) at a bottom corner, for example.

Attendants in the active people group or the user may be displayed as video feeds, if available. If video feed is not available, network conditions are not satisfactory, or computing resources are being conserved, representations (e.g., icons or pictures) of the attendants may be displayed instead of video feeds.

Example user interface 310 of FIG. 3A shows another configuration, where the presented content 312 is displayed in a prevalent mode. A group of dominant people 314 may be displayed in a floating fashion over the presented content. Dominant people 314 may be determined as discussed herein. A display location of the dominant people 314 may be static or dynamically selected based on the presented content 312. For example, if the presented content 302 includes a relatively static region (i.e., displayed information is not changing over time), the dominant people 314 in form of video feeds or representations may be displayed over that static region.

Example user interface 320 of FIG. 3A shows a split display configuration that includes dominant (or other) people 322, chat content 324, and other content 326. In some meetings, there may not be presented content such as graphics, text, or video. However, the online meeting may include people who participate via audio or video connection, as well as, people who participate via messaging. In such scenarios, the chat content 324 may display the exchanged messages in real time while the audio/video conversation is taking place. Other content 326 may include any content that may be relevant to the online meeting, but not important enough to be displayed in a prevalent fashion.

Example user interface 330 of FIG. 3B shows a configuration, where only attendants (people 332) are displayed. In a simple configuration, the display space may be divided into equal portions and video feeds or representations of the attendants may be displayed. In some examples, the displayed people 332 may be selected among active attendants, that is, attendants who are currently speaking or have spoken in the past and/or presented. In such examples, as new people being to speak or others do not speak for a predefined period, replacements may be made in the displayed active people dynamically.

Example user interface 340 in FIG. 3B shows a similar configuration to example user interface 330, where active people 342 are displayed in a substantially equally divided display space with the optional addition of a representation of content 344 to be presented and a representation of user 346 (attendant who is using the particular user interface). Thus, the user may be enabled to switch between the people view and content view by selecting the displayed representations. In embodiments, where video feeds of attendants are replaced with representations for any number of reasons, but are available, each user may be allowed to select a particular attendant's representation and view the corresponding video feed.

Example user interface 350 of FIG. 3B shows a gallery view with two groups of attendants displayed as active people 354 and inactive people 355 over canvas 352. The row of active people 354 may also be referred to as “standing row” and the row of inactive people 355 may also be referred to as “sitting row”. As active speakers change during the meeting, replacements may be made automatically between the two rows. As in example user interface 340, content 354 and user 356 representations may be optionally displayed to allow the user to be able to switch between different views. In an example scenario, an attendant determined to be a dominant speaker based on his/her attributes and/or current speaking status may be selected for the standing row. In addition, attendants who currently speak as well or who have spoken recently or for longest duration may be selected for the standing row. Attendants who have not spoken during the meeting or participated less than others (based on a predetermined or dynamic threshold) may be selected for the sitting row. In another example scenario, attendants who mute themselves during the meeting may be moved from the standing row to the sitting row.

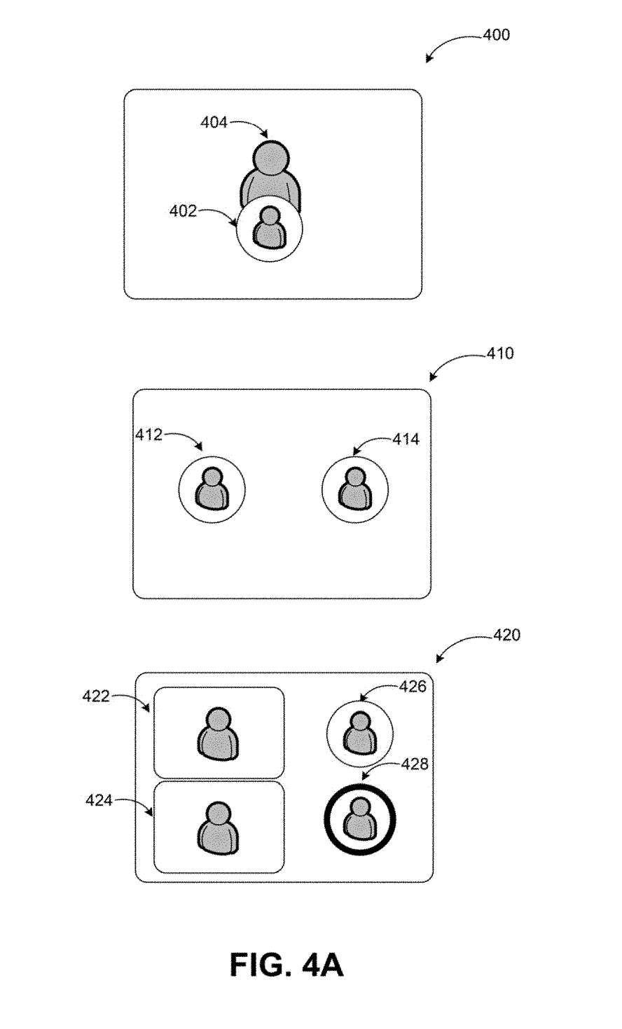

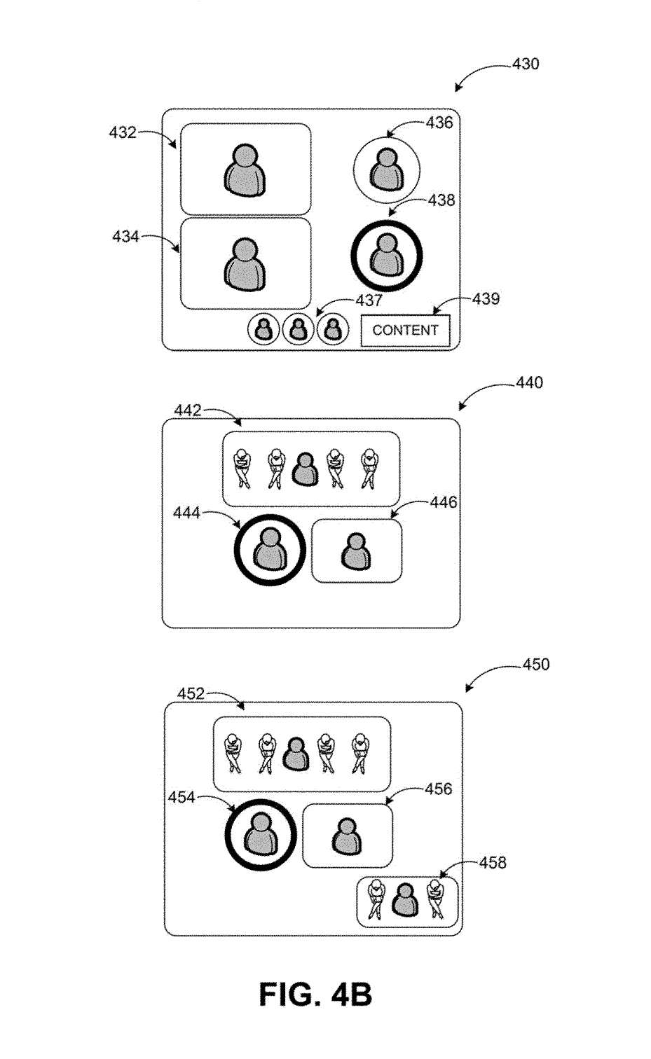

FIGS. 4A and 4B illustrate example distribution of people in gallery views in online meeting user interfaces.

User interface 400 of FIG. 4A shows a people-centric configuration for an online meeting between two people. An attendant 402 currently viewing the user interface may be displayed in a smaller form over the video feed of the other attendant 404. A display location of the attendant 402 may be dynamically selected based on activity in the video feed of the other attendant 404.

Example user interface 410 of FIG. 4A shows another example two-person online meeting, where the video feeds (or representations) of the attendants 412 and 414 are displayed on the user interface in substantially equal areas with the display split vertically (or horizontally).

Example user interface 420 of FIG. 4A shows a multi-attendant configuration, where two attendants 422 and 424 are presented with video feeds and two other attendants 426 and 428 are presented through representations (e.g., icons or pictures). Graphic, highlighting, color, shading, or comparable schemes may be used to indicate various information. For example, the representation of attendant 428 may be highlighted to indicate that attendant 428 is currently speaking (as other attendants may not be able to tell from the representation).

Example user interface 430 of FIG. 4B shows additional elements over the user interface 420. In addition to attendants 432 and 434 with video feeds and attendants 436 and 438 with representations, a representation of content 439 may be displayed to allow the user to switch to content view. Moreover, a select group of other attendants 437 (e.g., inactive attendants) may also be displayed as representations or video feeds in smaller form factor compared to the attendants 432, 434, 436, and 438.

Example user interface 440 of FIG. 4B shows a representation of attendant 444 with a highlighting scheme indicating that attendant 444 is currently speaking and a video feed of attendant 446. In addition, a remote panorama view 442 of multiple attendants in a conference room is also shown on the user interface. When panorama view is available, it may be displayed prominently in some user interfaces. In some examples, the panorama view 442 may be displayed below a standing row.

Example user interface 450 of FIG. 4B shows additional elements over the user interface 440. In addition to representation of attendant 454, video feed of attendant 456, and remote panorama view 452, a local panorama view 458 may also be displayed when available. In some examples, the local panorama view 458 may be displayed in smaller form factor compared to the remote panorama view 452. In some examples, the remote panorama view 452 may be displayed below a standing row.

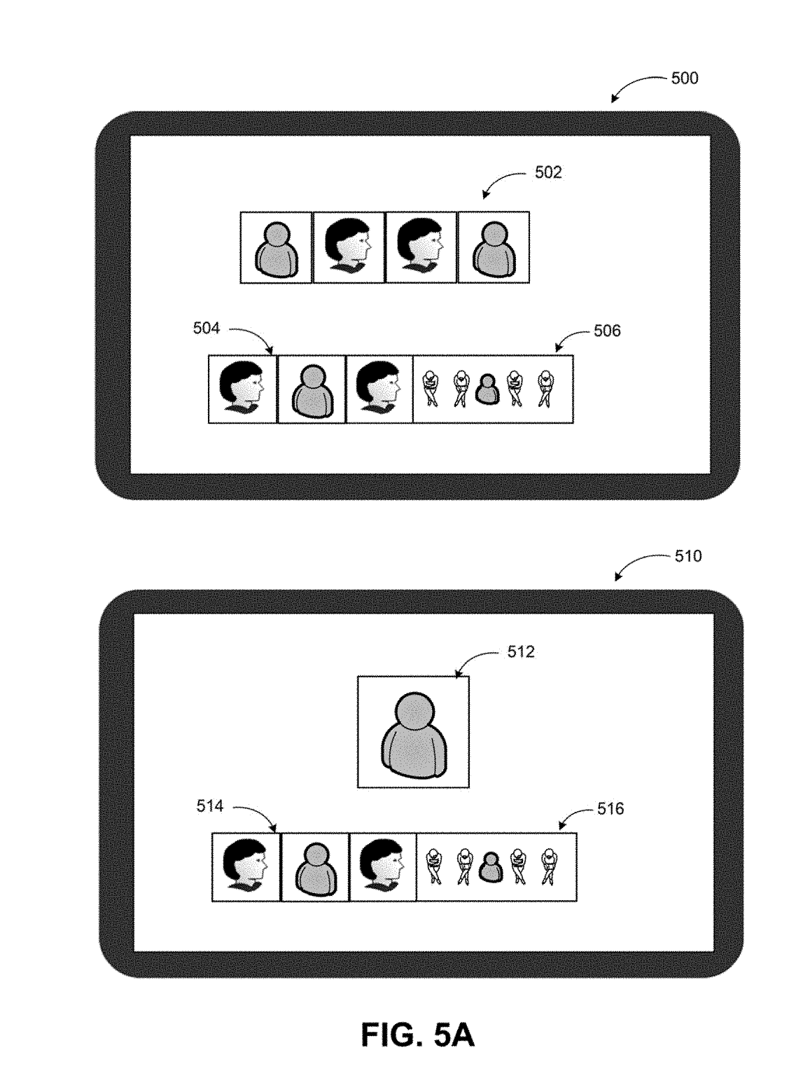

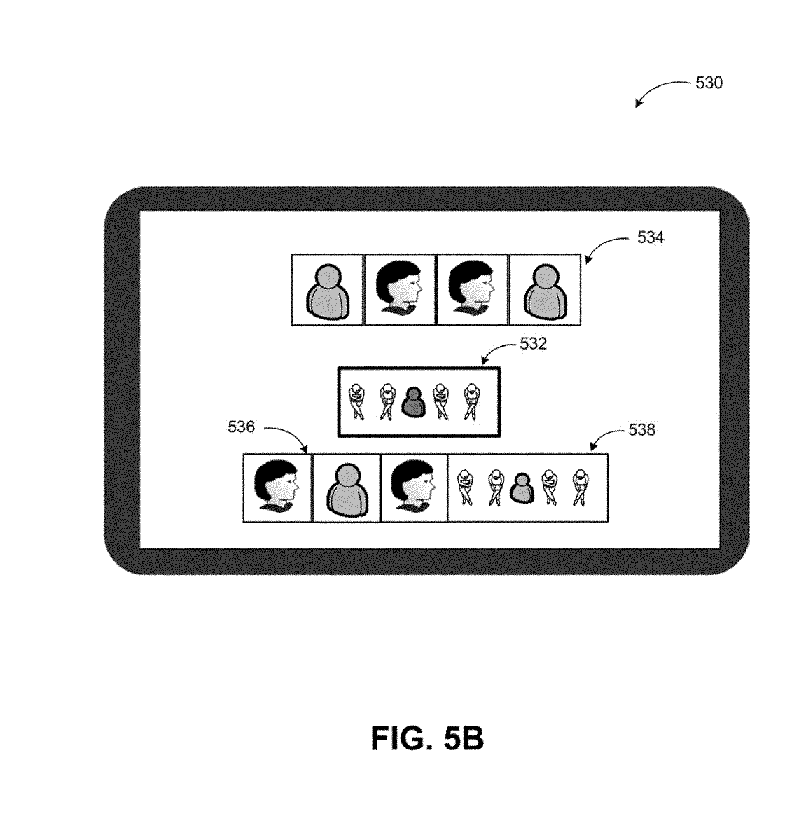

FIGS. 5A and 5B illustrate example user interfaces with different people display configurations.

Example user interface 500 in FIG. 5A shows active speakers in standing row 502 and inactive speakers in sitting row 504. A local panorama view 506 is also included adjacent to the sitting row 504. In some examples, a number of attendants displayed in the standing row 502 may begin with the first speaking or presenting attendant and increase until a predetermined limit is reached. Similarly, the sitting row 504 may be filled with a subset of attendants (if there are more attendants than available space in either row.

In some examples, the standing row 502 may be filled starting with a dominant speaker and adding other participants based on their participation or other criteria (for example, the meeting organizer, a representative of a geographic region/team/office location, or any other designated person). Participants may be moved up and down based on changes to their attributes (for example, their participation) between the standing row 502 and sitting row 504. The number of available spots in the standing row 502 may be defined by a default value, dynamically selected based on a number of participants, device or application characteristics, or other factors.

Panorama views are generated by special devices and encompass a larger/wider view of the environment. If a local panorama view (for example, an office of the meeting organizer, or a conference room) is available, it may be displayed at a dedicated location on the user interface. In the example user interface 500, the local panorama view 506 is displayed at the lower right corner as an extension of the sitting row 504. In other examples, the local panorama view 506 may be positioned at other locations on the user interface independent of the standing and sitting rows of the gallery.

Example user interface 510 of FIG. 5A shows the standing row being replaced with a single representation. In some examples, if attendants in the standing row do not speak or present for a predetermined period, they may be moved to the sitting row 514 or removed from the user interface completely. Thus, at one point, the standing row may be replaced with a single video feed or picture of a dominant speaker 512. In other examples, a user may choose to have only the dominant speaker in the top row. Panorama view 516 may be displayed as in example user interface 500.

Example user interface 530 of FIG. 51 shows two panorama views being displayed in addition to standing row 534 and sitting row 536. Local panorama view 538 may be displayed in a less prominent location, while remote panorama view 532 may be displayed in a prominent location below the standing row 534. In some embodiments, a dominant speaker in the remote panorama view may be focused on, that is, displayed as individual attendant on the user interface. In such examples, a full version of the remote panorama view may also be displayed at another location, for example, at the bottom of the user interface. In further examples, more than one remote panoramic view may be available and displayed sequentially, interchangeably, or in other fashion.

Participant representations in the gallery may include, but are not limited to, video feeds, pictures, icons, and similar items. A history of participation (when and for how long each participant speaks or presents) may be maintained through the use of timestamps for example. Based on the history, whether or not a participant has video feed, or random selection, the subset of participants may be selected to be represented in the gallery. Upon determination of a new dominant speaker (a currently speaking participant), one with less or no activity may be removed from the gallery and replaced with the dominant speaker.

The examples provided in FIGS. 1 through 5B are illustrated with specific systems, services, applications, modules, codes, and notifications. Embodiments are not limited to environments according to these examples. Gallery views in online meeting user interfaces may be implemented in environments employing fewer or additional systems, services, applications, engines, codes, and user experience configurations. Furthermore, the example systems, services, applications, modules, and notifications shown in FIG. 1 through 5B may be implemented in a similar manner with other values using the principles described herein. The example user interfaces in FIG. 3A through 5B are also shown with example elements and configurations for illustration purposes. Embodiments may be implemented with different numbers and types of elements (e.g., representations or video feeds), different layouts, and different graphic, highlighting, color, shading, and similar schemes to indicate various types of information about displayed elements.

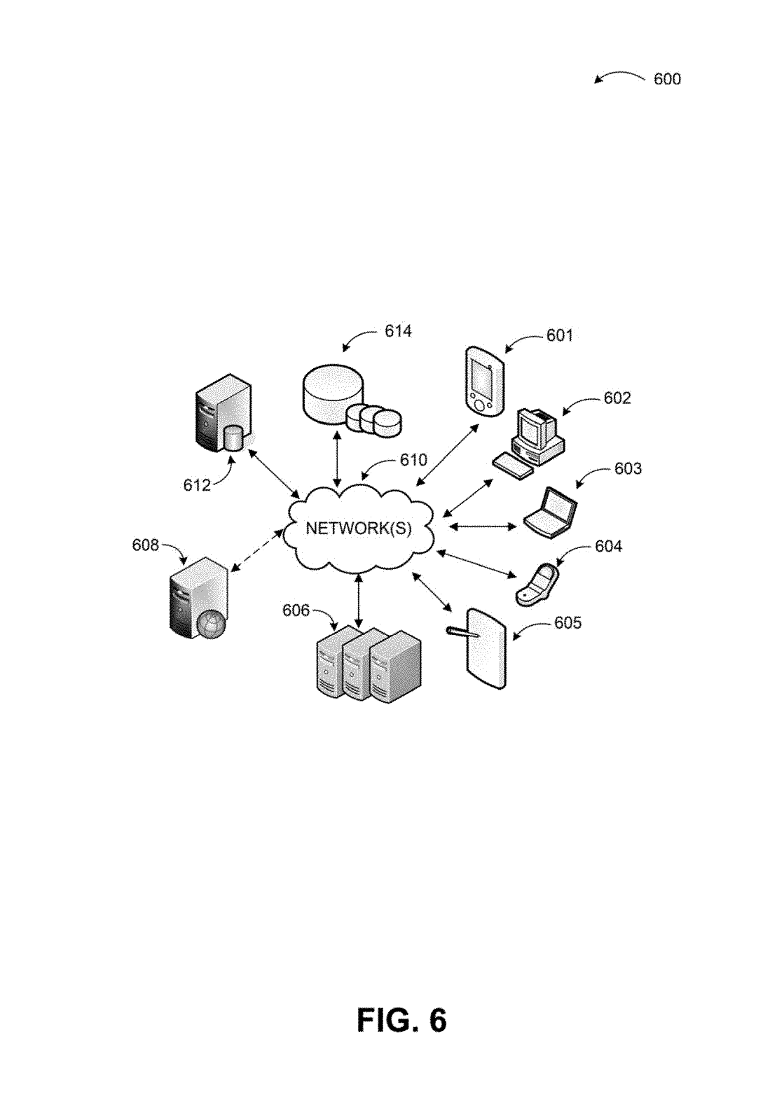

FIG. 6 is a networked environment, where a system according to embodiments may be implemented. In addition to locally installed applications (for example, communication application 106), gallery views in online meeting user interfaces may also be employed in conjunction with hosted applications and services (for example, a storage service 114) that may be implemented via software executed over one or more servers 606, individual server 608, or at client devices, as illustrated in diagram 600. A hosted service or application may communicate with client applications on individual computing devices such as a handheld computer 601, a desktop computer 602, a laptop computer 603, a smart phone 604, a tablet computer (or slate), 605 (‘client devices’) through network(s) 610 and control a user interface presented to users.

Client devices 601-605 are used to access the functionality provided by the hosted service or application. One or more of the servers 606 or server 608 may be used to provide a variety of services as discussed above. Relevant data such as meeting data and similar may be stored in one or more data stores (e.g. data store 614), which may be managed by any one of the servers 606 or by database server 612.

Network(s) 610 may comprise any topology of servers, clients, Internet service providers, and communication media. A system according to embodiments may have a static or dynamic topology. Network(s) 610 may include a secure network such as an enterprise network, an unsecure network such as a wireless open network, or the Internet. Network(s) 610 may also coordinate communication over other networks such as PSTN or cellular networks. Network(s) 610 provides communication between the nodes described herein. By way of example, and not limitation, network(s) 610 may include wireless media such as acoustic, RF, infrared and other wireless media.

Many other configurations of computing devices, applications, engines, data sources, and data distribution systems may be employed for gallery views in online meeting user interfaces. Furthermore, the networked environments discussed in FIG. 6 are for illustration purposes only. Embodiments are not limited to the example applications, engines, or processes.

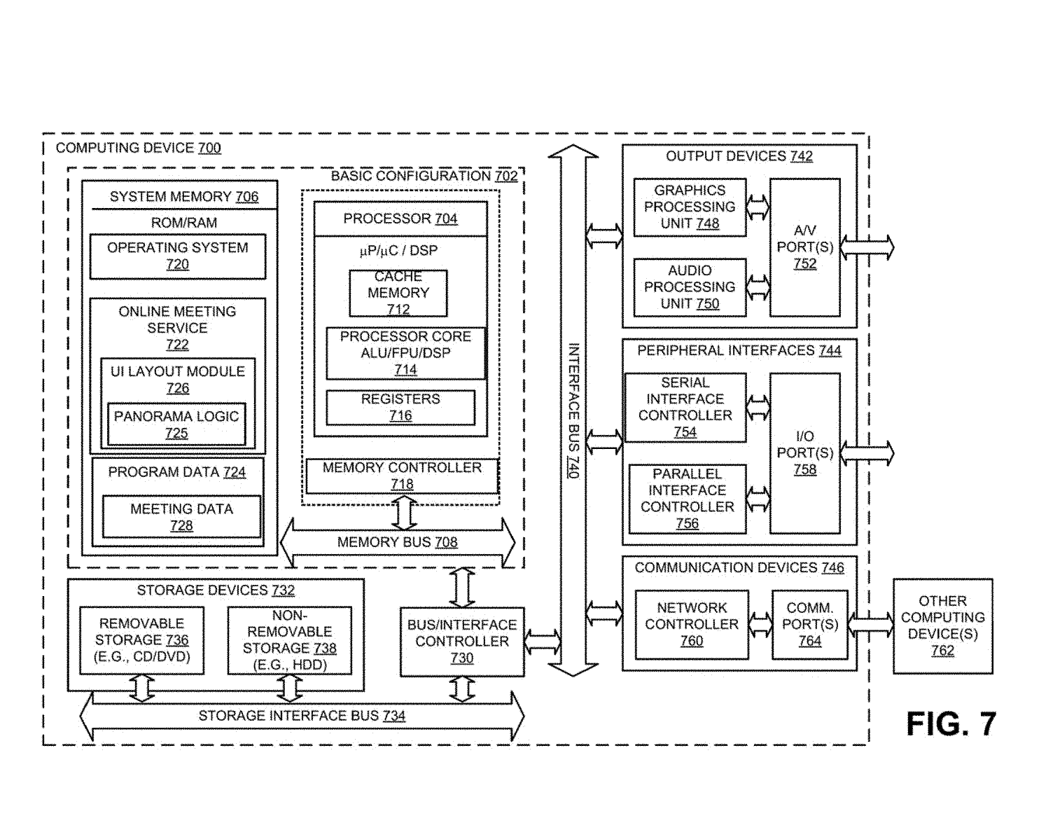

FIG. 7 is a block diagram of an example general purpose computing device, which may be used to provide gallery views in online meeting user interfaces.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communicating between the processor 704 and the system memory 706. The basic configuration 702 is illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations the memory controller 718 may be an internal part of the processor 704.

Depending on the desired configuration, the system memory 706 may be of any type including but not limited to volatile memory (such as RAM), non-volatile memory (such as ROM, flash memory, etc.) or any combination thereof. The system memory 706 may include an operating system 720, an online meeting service 722, a UI layout module 726, and program data 724. The UI layout module 726 may determine optimal presentation of people, content, and other items to be presented in an online meeting user interface based on predefined, customizable, and dynamic rules/factors, and arrange the layout of the online meeting user interface. In some examples, panorama view logic 725 may be used to detect and present local and remote panorama views within the online meeting user interface. The program data 724 may include, among other data, meeting data 728, as described herein.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 746 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer that includes any of the above functions. The computing device 700 may also be implemented as a personal computer including both laptop computer and non-laptop computer configurations.

Example embodiments may also include methods to provide gallery views in online meeting user interfaces. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

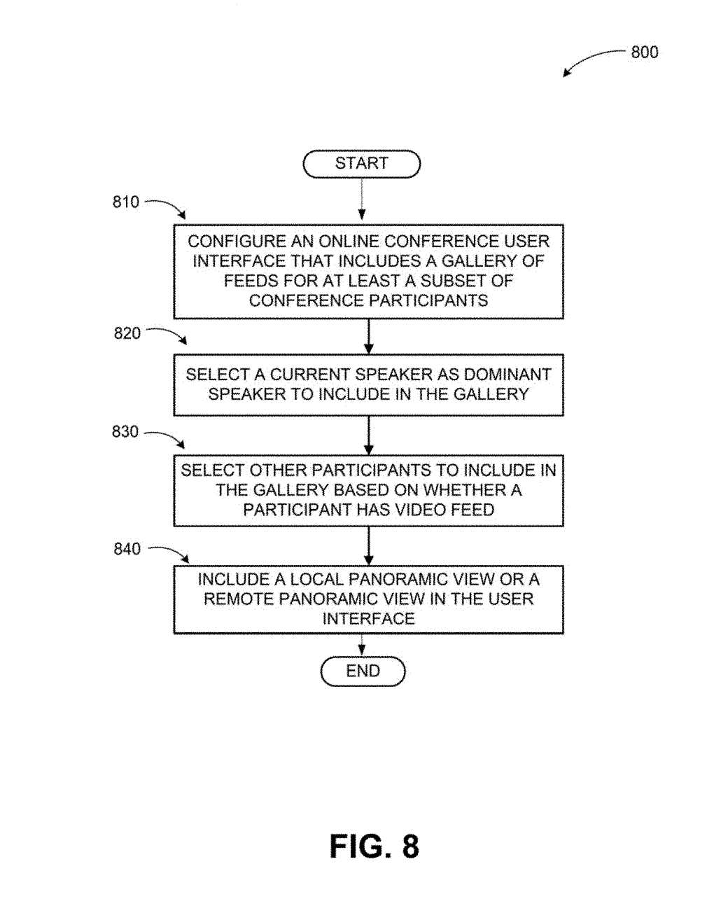

FIG. 8 illustrates a logic flow diagram of a method to provide gallery views in online meeting user interfaces.

Process 800 may be implemented on a computing device, server, or other system. An example system may include a computer communicatively coupled to a cloud server hosting an online meeting service.

Process 800 begins with operation 810, where a subset of participants to be represented in a gallery view may be determined based on one or more of a speaking status, a speaking history, a video feed status, and a random selection. At operation 820, a dominant speaker may be determined. Dominant speakers may be defined based on who is speaking, who is an important attendee, who is presenting, and similar factors.

At operation 830, the dominant speaker may be included in the gallery view by removing one of the subset of participants based on one or more of the speaking status, the speaking history, the video feed status of the subset of participants. At operation 840, the gallery view may be provided to a client application to be displayed.

The operations included in process 800 are for illustration purposes. Gallery views in online meeting user interfaces may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to examples, a means for providing gallery views in an online meeting user interface is described. The means may include a means for determining a subset of attendants to be represented in a gallery view based on one or more of a speaking status, a speaking history, a video feed status, and a random selection; a means for determining a dominant speaker; a means for including the dominant speaker in the gallery view by removing one of the subset of attendants based on one or more of the speaking status, the speaking history, the video feed status of the subset of attendants; and a means for providing the gallery view to be displayed to a client application.

According to some examples, a method to provide gallery views in an online meeting user interface is described. The method may include determining a subset of attendants to be represented in a gallery view based on one or more of a speaking status, a speaking history, a video feed status, and a random selection; determining a dominant speaker; including the dominant speaker in the gallery view by removing one of the subset of attendants based on one or more of the speaking status, the speaking history, the video feed status of the subset of attendants; and providing the gallery view to be displayed to a client application.

According to other examples, determining the dominant speaker may include analyzing a current speaking status, a past speaking status, a current presentation status, a past presentation status, and an attribute of each attendee. Determining the dominant speaker further may further include analyzing a duration of past speaking and a duration of past presentation of each attendee. The attribute of each attendee may include one or more of whether an attendee is an organizer of the online meeting, whether the attendee is an invited guest outside of an organization, and an organizational status of the attendee.

According to further examples, the method may also include arranging a first subset of the attendants in a standing row based on one or both of a current speaking status and a past speaking status; and arranging a second subset of the attendants in a sitting row based on one or both of the current speaking status and the past speaking status. The method may further include replacing one of the attendants in the standing row with another one of the attendants in the sitting row during the online meeting based on one or more of the current speaking status, the past speaking status, and whether an attendant has muted or un-muted themselves. The method may also include including the dominant speaker in the standing row or automatically adjusting a number of attendants in the standing row and a number of attendants in the sitting row based on one or more of additional content displayed on the online meeting user interface, an available display space, and a user input. The method may further include replacing one or more video feeds in the gallery view with static representations based on one or more of a change in availability of a video feed, a network connectivity status, and a user input.

According to other examples, a computing device to provide gallery views in an online meeting user interface is described. The computing device may include a communication interface configured to facilitate communication between the computing device and one or more servers; a memory configured to store instructions; and one or more processors coupled to the memory, where the one or more processors, in conjunction with the instructions stored in the memory, are configured to execute an online meeting service. The online meeting service may include a communication module configured to facilitate exchange of one or more modes of communication to facilitate an online meeting and a user interface layout module configured to determine a first subset of attendants and a second subset of attendants to be represented in a gallery view based on one or more of a current speaking status, a current presentations status, a past speaking status, a past presentation status, a video feed status, and a random selection; include the first subset of the attendants in a standing row; include the second subset of the attendants in a sitting row, where the standing row is configured to be displayed more prominently than the sitting row; replace one of the attendants in the standing row with another one of the attendants in the sitting row during the online meeting based on a change to one or more of the current speaking status, the current presentations status, the past speaking status, the past presentation status, the video feed status, and the random selection; and provide the gallery view to be displayed to a client application.

According to some examples, the user interface layout module may be further configured to receive a local panorama view associated with an attendant viewing the online meeting user interface; and provide the local panorama view to be displayed less prominently compared to the standing row and the sitting row. The user interface layout module may also be configured to receive a remote panorama view associated with another attendant; and provide the remote panorama view to be displayed more prominently compared to the standing row and the sitting row.

According to other examples, the user interface layout module may be further configured to focus on the dominant speaker upon detecting a dominant speaker in the remote panorama view based on one or more of a current speaking status, a past speaking status, a current presentation status, a past presentation status, and an attribute of each attendant in the remote panorama view; and move the remote panorama view to a less prominent location compared to the dominant speaker. The user interface layout module may also be configured to employ one or more of a graphic scheme, a highlighting scheme, a color scheme, and a shading scheme to indicate an attendant that is currently speaking or presenting. The online meeting user interface may include one or both of a presented content and a record of exchanged messages in addition to the gallery view.

According to further examples, a physical computer-readable memory device with instructions stored thereon to provide gallery views in an online meeting user interface is described. The instructions may include determining a first subset of attendants and a second subset of attendants to be represented in a gallery view based on one or more of a current speaking status, a current presentations status, a past speaking status, a past presentation status, a video feed status, and a random selection; including the first subset of the attendants in a standing row; including the second subset of the attendants in a sitting row, where the standing row is configured to be displayed more prominently than the sitting row; replacing one of the attendants in the standing row with another one of the attendants in the sitting row during the online meeting based on a change to one or more of the current speaking status, the current presentations status, the past speaking status, the past presentation status, the video feed status, and the random selection; upon detecting a dominant speaker in the remote panorama view based on one or more of a current speaking status, a past speaking status, a current presentation status, a past presentation status, and an attribute of each attendant in the remote panorama view, focusing on the dominant speaker; and providing the gallery view to be displayed to a client application.

According to some examples, the instructions may further include providing a representation of presented content to enable an attendant to switch from the gallery view to a content view. The gallery view may be minimized and a number of attendant representations in the gallery view may be reduced in response to the switch to the content view. The instructions may further include enabling an attendant currently viewing the online meeting user interface to switch a video feed of another attendant to a static representation. The instructions may also include selecting a number of attendants, a placement of the standing row, and a placement of the sitting row based on a user preference associated with an attendant currently viewing the online meeting user interface.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to provide gallery views in an online meeting user interface, the method comprising:
determining a subset of attendants to be represented in a gallery view based on one or more of a speaking status, a speaking history, a video feed status, and a random selection;
determining a dominant speaker;
including the dominant speaker in the gallery view by removing one of the subset of attendants based on one or more of the speaking status, the speaking history, the video feed status of the subset of attendants; and
providing the gallery view to be displayed to a client application.

2. The method of claim 1, wherein determining the dominant speaker comprises:
analyzing a current speaking status, a past speaking status, a current presentation status, a past presentation status, and an attribute of each attendee.

3. The method of claim 2, wherein determining the dominant speaker further comprises:
analyzing a duration of past speaking and a duration of past presentation of each attendee.

4. The method of claim 2, wherein the attribute of each attendee includes one or more of whether an attendee is an organizer of the online meeting, whether the attendee is an invited guest outside of an organization, and an organizational status of the attendee.

5. The method of claim 1, further comprising:
arranging a first subset of the attendants in a standing row based on one or both of a current speaking status and a past speaking status; and
arranging a second subset of the attendants in a sitting row based on one or both of the current speaking status and the past speaking status.

6. The method of claim 5, further comprising:
replacing one of the attendants in the standing row with another one of the attendants in the sitting row during the online meeting based on one or more of the current speaking status, the past speaking status, and whether an attendant has muted or un-muted themselves.

7. The method of claim 5, further comprising:
including the dominant speaker in the standing row.

8. The method of claim 5, further comprising:
automatically adjusting a number of attendants in the standing row and a number of attendants in the sitting row based on one or more of additional content displayed on the online meeting user interface, an available display space, and a user input.

9. The method of claim 1, further comprising:
replacing one or more video feeds in the gallery view with static representations based on one or more of a change in availability of a video feed, a network connectivity status, and a user input.

10. A computing device to provide gallery views in an online meeting user interface, the computing device comprising:
a communication interface configured to facilitate communication between the computing device and one or more servers;
a memory configured to store instructions; and
one or more processors coupled to the memory, wherein the one or more processors, in conjunction with the instructions stored in the memory, are configured to execute an online meeting service, the online meeting service comprising:
a communication module configured to facilitate exchange of one or more modes of communication to facilitate an online meeting; and
a user interface layout module configured to:
determine a first subset of attendants and a second subset of attendants to be represented in a gallery view based on one or more of a current speaking status, a current presentations status, a past speaking status, a past presentation status, a video feed status, and a random selection;
include the first subset of the attendants in a standing row;
include the second subset of the attendants in a sitting row, wherein the standing row is configured to be displayed more prominently than the sitting row;
replace one of the attendants in the standing row with another one of the attendants in the sitting row during the online meeting based on a change to one or more of the current speaking status, the current presentations status, the past speaking status, the past presentation status, the video feed status, and the random selection; and
provide the gallery view to be displayed to a client application.

11. The computing device of claim 10, wherein the user interface layout module is further configured to:
receive a local panorama view associated with an attendant viewing the online meeting user interface; and
provide the local panorama view to be displayed less prominently compared to the standing row and the sitting row.

12. The computing device of claim 10, wherein the user interface layout module is further configured to:
receive a remote panorama view associated with another attendant; and
provide the remote panorama view to be displayed more prominently compared to the standing row and the sitting row.

13. The computing device of claim 10, wherein the user interface layout module is further configured to:
upon detecting a dominant speaker in the remote panorama view based on one or more of a current speaking status, a past speaking status, a current presentation status, a past presentation status, and an attribute of each attendant in the remote panorama view, focus on the dominant speaker; and
move the remote panorama view to a less prominent location compared to the dominant speaker.

14. The computing device of claim 10, wherein the user interface layout module is further configured to:
employ one or more of a graphic scheme, a highlighting scheme, a color scheme, and a shading scheme to indicate an attendant that is currently speaking or presenting.

15. The computing device of claim 10, wherein the online meeting user interface includes one or both of a presented content and a record of exchanged messages in addition to the gallery view.

16. A physical computer-readable memory device with instructions stored thereon to provide gallery views in an online meeting user interface, the instructions comprising:
determining a first subset of attendants and a second subset of attendants to be represented in a gallery view based on one or more of a current speaking status, a current presentations status, a past speaking status, a past presentation status, a video feed status, and a random selection;
including the first subset of the attendants in a standing row;
including the second subset of the attendants in a sitting row, wherein the standing row is configured to be displayed more prominently than the sitting row;
replacing one of the attendants in the standing row with another one of the attendants in the sitting row during the online meeting based on a change to one or more of the current speaking status, the current presentations status, the past speaking status, the past presentation status, the video feed status, and the random selection;
upon detecting a dominant speaker in the remote panorama view based on one or more of a current speaking status, a past speaking status, a current presentation status, a past presentation status, and an attribute of each attendant in the remote panorama view, focusing on the dominant speaker; and
providing the gallery view to be displayed to a client application.

17. The computer-readable memory device of claim 16, wherein the instructions further comprise:
providing a representation of presented content to enable an attendant to switch from the gallery view to a content view.

18. The computer-readable memory device of claim 17, wherein the gallery view is minimized and a number of attendant representations in the gallery view reduced in response to the switch to the content view.

19. The computer-readable memory device of claim 16, wherein the instructions further comprise:
enabling an attendant currently viewing the online meeting user interface to switch a video feed of another attendant to a static representation.

20. The computer-readable memory device of claim 16, wherein the instructions further comprise;
selecting a number of attendants, a placement of the standing row, and a placement of the sitting row based on a user preference associated with an attendant currently viewing the online meeting user interface.
